(19) United States
(12) Patent Application Publication
(10) Pub. No.: US 2014/0164789 A1
(43) Pub. Date: Jun. 12, 2014

(54) AUTHENTICATING MICROCODE PATCHES WITH EXTERNAL ENCRYPTION ENGINE

(71) Applicant: ADVANCED MICRO DEVICES, INC., Sunnyvale, CA (US)

(72) Inventor: David A. Kaplan, Austin, TX (US)

(73) Assignee: Advanced Micro Devices, Inc.

(21) Appl. No.: 13/708,782

(22) Filed: Dec. 7, 2012

(51) Int. Cl. G06F 21/44

(52) U.S. Cl. CPC G06F 21/44
USPC 713/191

(57) ABSTRACT

A single or multicore processor having a separate hardware cryptographic engine (HCE) for microcode patch updates is presented. Microcode in each core is modified to utilize the HCE for patch updates. Various arrangements are presented. Memory for HCE processing can include shared L2 or L3 memory or a separate DRAM configured in the address space of each core or set of cores and the HCE. In some embodiments, the HCE may be located on a circuit card attached to an extension bus, such as a PCIe or LPC bus.

### TECHNICAL FIELD

Generally, the present disclosure relates to microprocessors, and, more particularly, to the use of a hardware cryptographic engine to authenticate microcode patches for a multicore processor.

### BACKGROUND

CPUs today contain a complex set of firmware, called microcode, used to implement many of the features in the microprocessor. Complex instructions, power management, interrupts, etc., are all broken down by microcode into a sequence of operations the hardware can natively execute. Because of the size and complexity of microcode, problems in the coding may be introduced. Many modern processors have the ability to “patch” this code in the field via a software update mechanism. This mechanism typically loads a hardware RAM with new firmware to fix the bugs present in the microcode.

Because malicious microcode could compromise a system at its lowest level, microcode patches must be made security sensitive. For example, a CPU may authenticate microcode updates by computing a hash value over the patch data and comparing the hash value to a value supplied with the update and signed with a cryptographic signature. If a CPU cannot decrypt and authenticate the patch successfully, it will not accept the microcode update and the update will be ignored. A microcode update may be initiated by software such as BIOS, downloaded from a site, or be part of an operating system update distributed by a third party.

FIG. 1 shows a routine known in the art for installing microcode patches. Such a routine is typically hardcoded into a CPU's microcode ROM. The routine begins with a software command, such as a WRMSR (write machine-specific register) instruction, to initiate the update 100. The command is typically issued with a pointer to the microcode update image. The on-chip microcode then processes the command accordingly. The routine first prepares some local storage 101 into which the patch data is copied. For security purposes, this storage is typically a region of memory not accessible to normal software. For example, it could be a section of DRAM reserved for CPU microcode, a reserved section of the CPU cache, or some/all of the CPU cache when the CPU is place in isolation mode. For isolation mode, see U.S. Patent Application No. 2011/0131381, incorporated herein by reference. After preparing the local storage, the CPU copies the patch data into storage 102 and begins processing it. This may include computing a cryptographic hash (e.g. SHA1, MD5, etc) over the patch data 103 and comparing the hash to a value stored in a header field provided with the patch image. As understood by one of ordinary skill in the art, the header is typically encrypted using the private key of the entity that provided the patch. The microcode decrypts the header using the entity's public key, which is stored in whole or in part (e.g. with a hash) in the on-chip ROM. The microcode decrypts the header using an asymmetric key algorithm, such as RSA or ECC (104), though a symmetric key and key algorithm could be used if the security policy allows for such.

Integrity checks are typically performed on the header. If during processing, authentication or integrity checks fail, flow proceeds to 106 where the local storage is restored (if necessary) and a fault is reported to software, indicating the load failed. If all checks pass, the CPU copies 107 the new patch data into an on-chip RAM, restores the data, and exits with success. In a microprocessor having, for example, multiple processing cores (e.g., sixteen CPUs), each processing core would execute its own microcode update routine from its own respective microcode area, even though the microcode patch may be the same for each CPU. This results in additional power consumption over, e.g., a single-CPU design, as the process is redundantly repeated for each core.

There are two primary problems with the prior art approach. First is the size of the microcode required to perform the update operations and, particularly, the cryptographic routines in blocks 103 and 104. Microcode is typically stored in Read-Only Memory (ROM). If these routines can be removed and/or the patch update process streamlined, a smaller ROM may be used. Larger ROM sizes translate into more chip area and greater cost and power consumption.

The second is the length of time it takes to update the microcode when an update is needed. The patch loading routine may be very slow a id typically occurs during system boot or resumption from a standby state. Consequently, the microcode patch update process adds to the critical wake-up time for the system. It is desirable that, when the system boots or resumes from a standby state, it be ready within a small amount of time. Because this operation is in the critical wake-up or power-on path and may take milliseconds to complete depending on the exact algorithm, patch size, key size, and other factors, it is desirable to have a more efficient means to load, update, and authenticate microcode patches, particularly for microprocessors having multiple processing cores.

### SUMMARY OF EMBODIMENTS

The disclosed subject matter authenticates microcode patches using an external hardware cryptographic engine (HCE) accessible to the processing core (or cores) of a microprocessor. The HCE may be provided on the same chip as the processing core(s), on a separate chip configured within the address space of the microprocessor, or on a circuit board accessible to the microprocessor via an extension bus, such as a PCIe or Low Pin Count (LPC) bus. Other suitable locations may exist. An HCE acts as an accelerator and includes special hardware optimized to handle cryptographic algorithms.

In some embodiments, the CPU accesses the HCE via memory mapped input/output (MMIO) operations and is capable of performing cryptographic operations, like computing a SHA hash, performing an RSA decrypt, etc., on patch data in a very short amount of time compared to microcode operations. In some embodiments, each processor in a multicore processing system is configured to request a microcode patch authentication with the HCE over a system bus. After the HCE performs the requested action, it returns or stores the result in a register or other storage area where the CPU obtains it. Each processing core can continue performing other tasks while the HCE performs the requested authentication or becomes available to perform a requested authentication. Alternatively, each processing core may arbitrate for HCE resources and, once obtained, wait until the requested action is complete before proceeding to other tasks. In some embodiments, the HCE processes each processing core's patches sequentially in an order hardcoded into ROM or determined by BIOS or other means. In some embodiments, a computer system having a general-purpose HCE accelerator accessible to application programs and operating system software for performing general-purpose cryptographic functions is modified for use in authenticating microcode patches. The HCE accelerator may be located on a PCIe card or an LPC card and accessible via memory-mapped input/output (MMIO) operations.

Some embodiments include an apparatus comprising a first CPU having a storage location for microcode and one HCE configured to be accessible thereto for authenticating all or a portion of the microcode. In some embodiments, the apparatus includes a special purpose memory accessible to the first CPU and the HCE for authenticating a microcode patch. The memory can be a DRAM accessible to both the CPU microcode and the HCE via a shared address space. In this arrangement, the CPU copies the update image into the DRAM and then instructs the HCE to operate on the data, such as decrypt the patch data, verify the signature, and perform the integrity tests. The CPU monitors the progress of its requests by, e.g., reading status bits on the HCE. When the status bits indicate that a request is complete, the CPU reads out the results.

A non-transitory computer readable medium comprising a data structure which is operated upon by a program executable on a computer system, the program operating on the data structure to perform a portion of a process to fabricate an integrated circuit including circuitry described by the data structure, the circuitry described in the data structure including: a first processing unit including a storage area for microcode; and a hardware cryptographic engine (HCE) configured to be accessible to the first processing unit for authenticating all or a portion of the first processing unit's microcode.

A method, in accordance with some embodiments, includes copying microcode patch data into a storage area, instructing a HCE to perform a cryptographic operation on the microcode patch data, and obtaining the results of the cryptographic operation. The method may further comprise testing for the availability of the HCE before instructing the HCE to perform the cryptographic operation and/or obtaining an address of the HCE from a software routine, such as a routine in BIOS.

Utilizing an external HCE for authenticating microcode has many benefits. First, it reduces the size of the microcode image that must be stored in ROM, thereby reducing ROM size, chip area, and power consumption. This is particularly true for multicore processors, as cryptographic algorithms used to authenticate microcode patches require a large amount of memory, and each core would retain its own copy of the algorithms.

Faster speeds may also be achieved. Designers typically optimize microcode for memory size and not execution speed in order to keep ROM size small. By offloading microcode patch authentication to an external hardware accelerator, greater efficiency and speed can be achieved. For example, a HCE can perform cryptographic algorithms much faster than a general purpose CPU operating out of microcode, as it is specially designed to perform such functions. Additional security may be further provided because an HCE may support algorithms and key sizes that are not practical for implementation in microcode.

As one of ordinary skill in the art would understand, many variations exist and the embodiments described herein are not limiting.

### BRIEF DESCRIPTION OF THE FIGURES

The disclosed subject matter will hereafter be described with reference to the accompanying drawings, wherein like reference numerals denote like elements, and:

FIG. 1 is a simplified flow chart illustrating a routine for updating microcode in a microprocessor, as was known in the prior art.

FIG. 2 is a simplified flow chart illustrating a routine for updating microcode in a semiconductor device, in accordance with some embodiments.

FIG. 3 is a simplified block diagram of a microcircuit design having multiple CPUs and one BCE arranged in accordance with some embodiments.

FIG. 4 is a simplified block diagram of a computer system having one or more extension buses, such as a PCIe bus, arranged in accordance with some embodiments.

While the disclosed subject matter is susceptible to various modifications and alternative forms, specific embodiments thereof have been shown by way of example in the drawings and are described in detail herein. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims,

### DETAILED DESCRIPTION

Microcode is a layer of hardware-level instructions and/or data structures in computers and other processors that translates machine instructions into circuit-level commands or operations. By separating machine instructions from the underlying hardware, machine instructions can be designed and altered more freely and used to build more complex, multi-step instructions while reducing the complexity of the underlying electronic circuitry.

Microcode is typically stored in a special high-speed memory, such as Read Only Memory (ROM), a Programmable Logic Array (PLA), or a combination of both, hut may also be stored in SRAM or flash memory. Complex digital circuits that include microprocessors may employ two or more microcode-based control units to perform two or more tasks concurrently. Microcode is generally not visible or accessible to a programmer and, unlike machine code which often retains some compatibility among different processors in a family, runs only on the electronic circuitry for which it is designed. Microcode typically constitutes an inherent part of the processor or digital circuit design and its specific features and functionality are usually only known to the manufacturer. Like any other code, microcode can contain bugs that must be fixed. Fixes can be referred to as “patches” or updates. A “patch” or update can include the whole microcode image, or a portion thereof, and can include new or additional features not present in the existing microcode.

Patches or updates can come from many sources. They may be downloaded directly from the Internet, issued as part of an operating system update, or distributed by the manufacturer by any other means. In each case, the integrity and authenticity of the patch must be verified for security reasons. To ensure the integrity and authenticity of an update, the manufacturer or entity issuing the update typically computes a hash over the patch data and signs it using, e.g., a private key. The corresponding public key is either distributed at run-time or, more typically, installed in whole or in part on the system hosting the microcode. Such patches can be authenticated using a HCE.

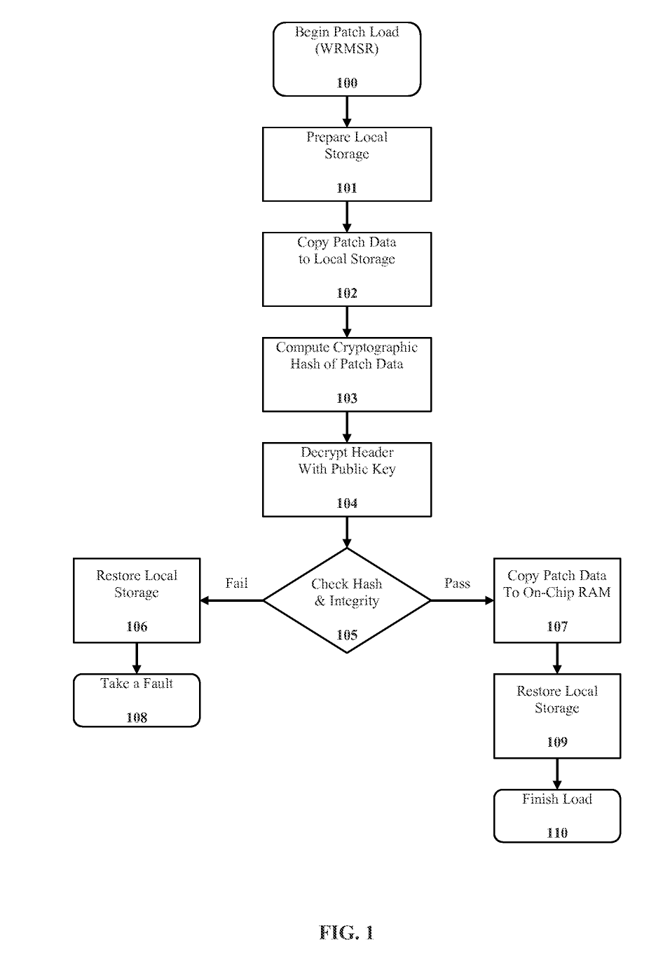

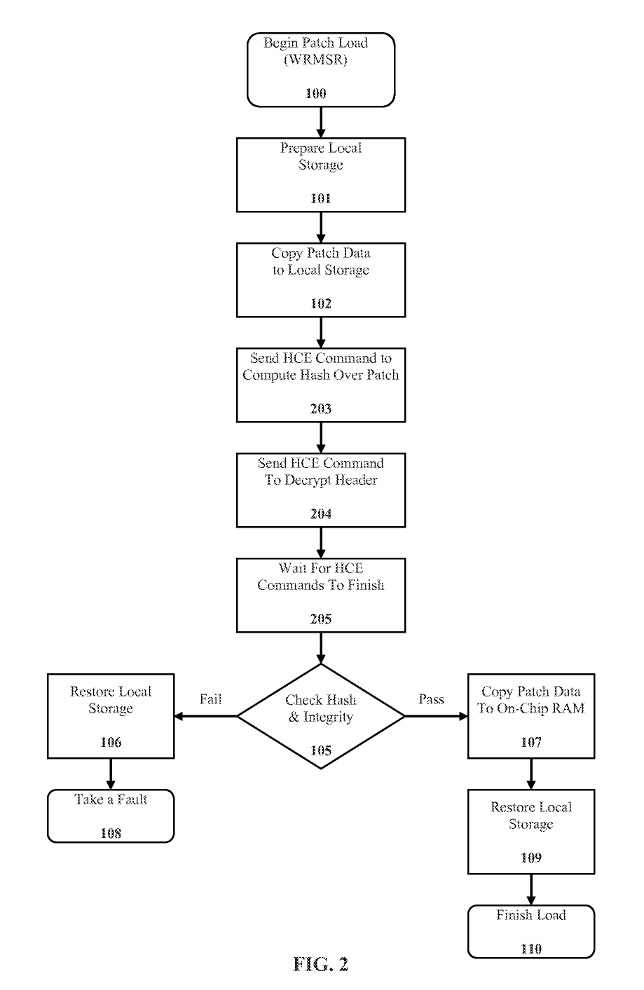

FIG. 2 is a simplified flow chart illustrating a routine for updating microcode in a semiconductor device in accordance with some embodiments. Similar to FIG. 1, the process begins with a software command, such as a WRMSR (write machine-specific register) instruction, to initiate the update 100. The command is typically issued with a pointer to the microcode update image. The on-chip microcode then processes the command accordingly. The routine prepares local storage 101 for HCE processing. Local storage can be any of L1, L2, or L3 cache, as described in more detail below, or can be a separate DRAM accessible only by the microcode of the respective CPU cores and the HCE or some other memory area, such as an SRAM. If a special DRAM or other memory area, such as a cache, is used, the hardware may need to isolate the memory from other components so that other code cannot access it during authentication. If the local storage is a cache, preparation includes clearing out the cache to make room for patch processing. The CPU then copies (102) the patch data into the cache, or, alternatively, into the private DRAM region, and a command is sent to the HCE to compute a hash (e.g. SHA1, MD5, etc.) 203. The CPU then sends a command to the HCE to decrypt the header portion of the update 204. The CPU then waits for the commands to complete 205. During this period, the CPU may optionally perform other tasks. Once the HCE has executed the requested tasks, the CPU checks the results 105. This may include comparing the computed hash value to a value stored in a header field provided with the patch image after the patch data has been verified with a signature.

If, during processing, any of these checks fail, flow proceeds to 106, where the local storage is restored (if necessary) and a fault 108 is reported, indicating the load failed, if all checks pass, the CPU copies 107 the new patch data into on-chip RAM or other memory, restores the data in local storage 109, if appropriate, and exits with success 110. The primary difference between the routine of FIG. 1 and FIG. 2 is in steps 203 and 204, where an HCE performs those tasks rather than the microcode. Additionally, steps 101, 106, and 109 may be ignored if a separate DRAM is used rather than, e.g., a cache, which must be cleared and restored, if used.

In some embodiments, each processing core communicates with the HCE by performing one or more register writes, such as memory-mapped I/O (MMIO) writes, and provides the HCE with the information it needs, such as the memory addresses to the source and destination buffers and any other parameters, to complete the requested operation. Parameters may include the encryption key and the cryptographic algorithm to use for the patch. The HCE then performs the requested action and informs the processing core of the result by, e.g., sending an interrupt to the CPU or setting a bit in a status register that the CPU polls to determine completion.

The HCE is capable of performing these operations much faster than the CPU, thereby speeding up the patch update process, because the HCE is specifically designed to perform the above-mentioned tasks. Moreover, it may be capable of performing steps 103/104 in parallel, further enhancing the speed and efficiency of the process.

The HCE may handle requests or commands using hardware queues or in-memory queues using, e.g., ring buffers. Each CPU submits its request to the queue. The request may contain memory addresses that point to any associated parameters applicable to the request, such as source and destination buffers, encryption keys, and any other parameter. The HCE reads each request from the queue, locates the appropriate source and destination buffers and other parameters, and processes the request accordingly. As discussed above, the HCE can be a general purpose cryptographic accelerator for performing a wide range of cryptographic functions for operating system software and even application-level software. The general-purpose HCE may even have a side engine or special purpose resources dedicated to authenticating microcode.

The HCE may thwart (or be designed to thwart) side-channel attacks, i.e., attacks based on information gained from the physical implementation of the cryptosystem rather than from weaknesses in the cryptographic algorithms, for example. Timing information, power consumption, or electromagnetic leaks can comprise an extra source of information that can be exploited by a knowledgeable hacker to break the system. Side-channel attacks are known in the art.

When designing multicore chips, a designer may implement each core with a private, local cache or choose to share one or more caches among multiple cores. Sharing one or more caches across different cores introduces more wiring and complexity to the design but greatly reduces the amount of space needed on the chip. Sharing an L1 cache is undesirable, however, because the added latency due to sharing the cache results in each core running slower than a single-core chip. Most multicore designs utilize various levels of cache, such as L1, L2, and L3, for efficiency.

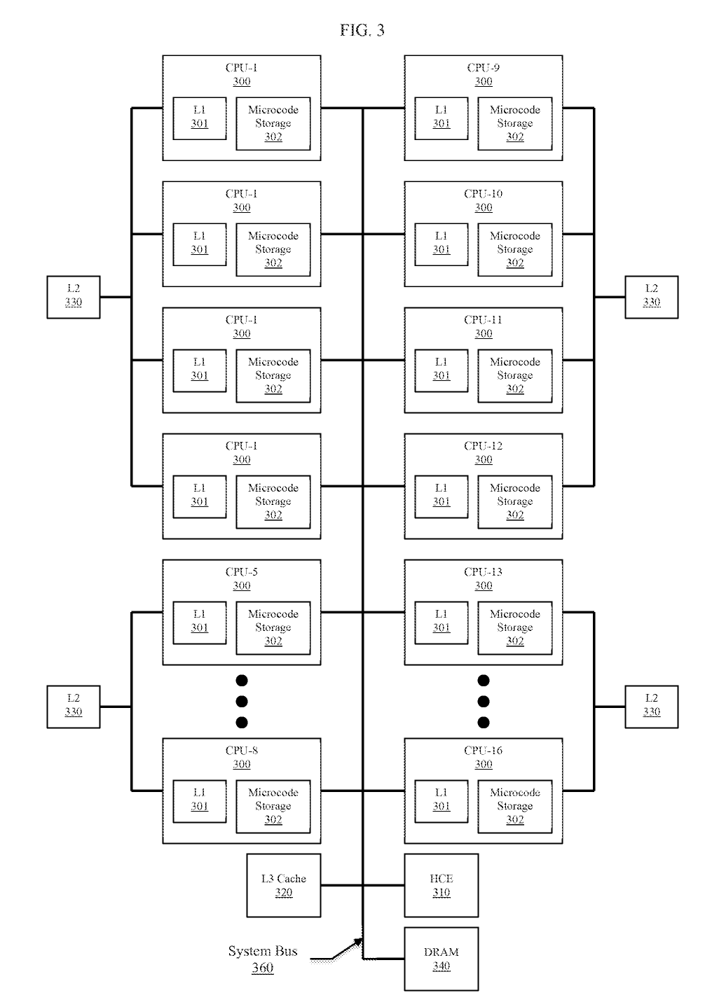

FIG. 3 is a simplified block diagram of a microcircuit design having multiple CPUs and one HCE arranged in accordance with at least in some embodiments. The microcircuit design contains 16 processing cores 390, utilizes one L1 cache 301 for each core 300, and shares one L2 cache 330 among a set of four cores and one L3 cache 320 among all 16 cores 300. Having a global cache, like L3 320, is desirable for several reasons. For example, some embodiments include one HCE 310 and one L3 cache 320 shared among all cores. The L3 cache 320 is placed in the address space of each core and the HCE 310. When servicing each of the cores, patch data can be loaded into the L3 cache 320 by each core and the HCE 310 then used to process the data. Since each core has access to the L3 cache, the HCE 310 can operate out of a single memory area accessible to each of the 16 cores. Alternatively, the same multicore design can implement any number of HCE's, such as four, each connected to system bus 360 to service each of the cores. Each HCE is configured in the address space of each of the cores 300, and each core 300 can arbitrate amongst the others for use of any one of the HCEs 310.

In some embodiments, a separate DRAM 340 is provided for HCE 310 services apart from the L3 cache 320, for updating the microcode. While this arrangement utilizes more chip area when the L3 cache 320 is present in the design, it removes the need to clear and restore data in the L3 cache when the HCE services are used. DRAM 340 may be sized to provide enough space for all or any number of HCEs to operate in parallel or allow each core to arbitrate and obtain memory space as needed for authenticating each patch.

Each HCE is a resource. When multiple cores share one or several HCEs, the cores must contend with each other for their services. This is because each CPU typically has its own microcode area to update and each CPU must be patched individually. Resource contention could be handled in different ways. For example, software could load patches sequentially on multiple CPUs. Alternatively, the CPUs could arbitrate amongst themselves for HCE resources. Arbitration schemes for resources are known in the art, and any arbitration scheme may be used. One scheme would be to provide a busy bit in the EWE that indicates if the HCE is currently being used by another CPU. CPUs could then do an atomic test-and-set operation to allow one CPU to obtain control of the HCE and request its services. Once the HCE completes the request, the CPU can then release it.

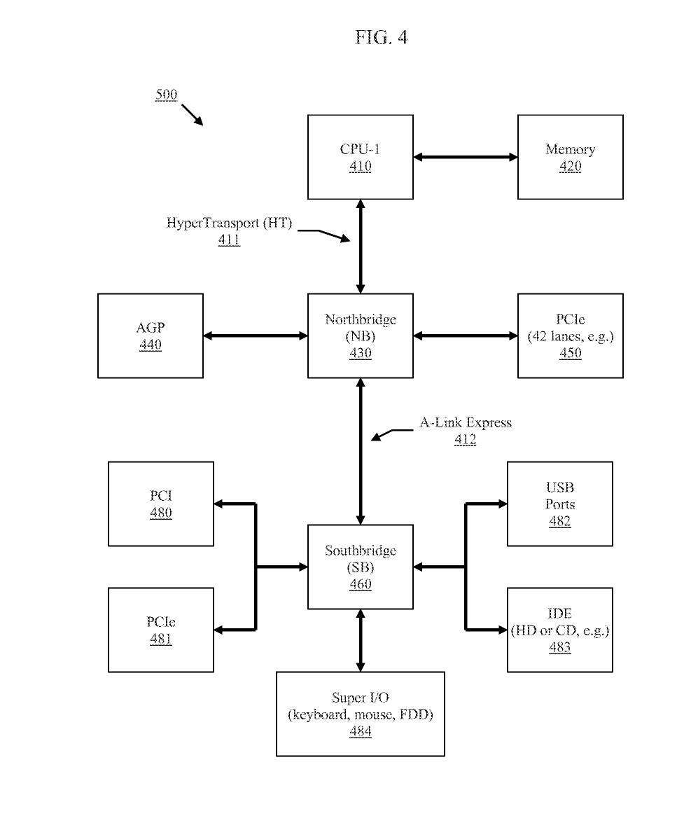

The HCE could also be located on hardware separate from the microprocessor. For example, the HCE may be located on a circuit card connected to the microprocessor via a Peripheral Component Interconnect Express (PCIe) bus, or some other bus, like an LPC bus. FIG. 4 illustrates one example of this embodiment. CPU 410 connects via a HyperTransport 411 bus to a Northbridge (NB) 430, which in turn connects an Accelerated Graphics Port (AGP) 440 and a set of PCIe lanes 450 (totaling, e.g., forty-two in the instant embodiment) to CPU 410. CPU 410 may have the NB 430 integrated therein. Memory 420 for processing the patch may be directly connected to CPU 410 through the motherboard or to NB 430 (not shown). One or more HCEs may be installed on one or more PCIe cards inserted into one or more of the PCIe slots 450. BIOS or some other software determines the addresses of the PCIe cards, preferably at boot time, and informs the microcode what addresses to use for the HCE or HCEs. As known by one of ordinary skill in the art, memory for processing the patch may be located on the PCIe cards, as well.

In some embodiments, the HCEs are located on, for example, an expansion bus connected to the Southbridge (SB) 460. Like with the NB 430, software determines the addresses of the circuit cards containing the HCEs and informs the microcode of the addresses to use. The SB 460 may be connected to the NB 430 via an A-Link Express bus typically known in the art or through any other type of bus. The SB 460 could also be integrated into the CPU 410, as with the NB 430. Moreover, the BCE when attached to a PCIe or LPC and connected to, e.g., the NB 430 or SB 460, also may be integrated into the same die as the CPU.

The HCE described in the embodiments above can be used exclusively for microcode patches or alternatively made accessible to operating system or application-level software for other cryptographic purposes. Due to the large number of security needs in computer systems today, more and more computer systems come equipped with an HCE external to the CPU(s). Making this HCE available for microcode patches provides a further improvement in the art.

The CPU microcode may use different methods to access the HCE. Microcode having direct access to an HCE could use, e.g., fixed, hard-coded addresses or addresses supplied by software, as described above. Some combination of fixed, hard-coded addresses and addresses supplied by software is also possible, depending on the arrangement.

Multicore processors having one or more HCEs may be formed on a semiconductor material by any known means in the art. Forming can be done, for example, by growing or deposition, or by any other means known in the art. Different kinds of hardware descriptive languages (HDL) may be used in the process of designing and manufacturing such microcircuit devices. Examples include VHDL and Verilog/Verilog-XL. In some embodiments, the HDL code (e.g., register transfer level (RTL) code/data) may be used to generate GDS data, GDSII data and the like. GDSII data, thr example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units, RAMs, compact discs, DVDs, solid state storage and the like) and, in some embodiments, may be used to configure a manufacturing facility (e.g., through the use of mask works) to create devices capable of embodying various aspects of the disclosed embodiments. As understood by one or ordinary skill in the art, it may be programmed into a computer, processor or controller, which may then control, in whole or part, the operation of a semiconductor manufacturing facility (or fab) to create semiconductor products and devices. These tools may be used to construct the embodiments described herein.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

What is claimed is:

1. An apparatus comprising:
a first processing unit including a storage area for microcode; and
a hardware cryptographic engine (HCE) configured to be accessible to the first processing unit for authenticating all or a portion of the first processing unit's microcode.

2. The apparatus of claim 1, further comprising a separate memory area configured to be accessible to the first processing unit and the HCE for authenticating at least a portion of the first processing unit's microcode.

3. The apparatus of claim 1, wherein the HCE is located on an extension bus.

4. The apparatus of claim 2, wherein the separate memory area includes a cache.

5. The apparatus of claim 2, wherein the first processing unit, the HCE, and the separate memory area are located in a single packaged unit.

6. The apparatus of claim 2, wherein the first processing unit, the HCE, and the separate memory area are located on the same semiconductor substrate.

7. The apparatus of claim 3, wherein the extension bus is a PCIe or LPC bus.

8. The apparatus of claim 1, further comprising:
a second processing unit including a storage area for microcode;
a memory area configured to be accessible to the HCE and the first and second processing units; and
wherein the HCE is configured to be accessible to the second processing unit for authenticating at least a portion of the second processing unit's microcode.

9. The apparatus of claim 8, wherein the first and second processing units are configured to arbitrate for the services of the HCE.

10. The apparatus of claim 8, wherein the first and second processing units, the HCE, and the memory area are located in a single packaged unit.

11. The apparatus of claim 9, wherein the HCE is located on an extension bus.

12. The apparatus of claim 10, wherein the first and second processing units, the HCE, and the memory area are located on the same semiconductor substrate.

13. A non-transitory computer readable medium comprising a data structure which is operated upon by a program executable on a computer system, the program operating on the data structure to perform a portion of a process to fabricate an integrated circuit including circuitry described by the data structure, the circuitry described in the data structure including:
a first processing unit including a storage area for microcode; and
a hardware cryptographic engine (HCE) configured to be accessible to the first processing unit for authenticating all or a portion of the first processing unit's microcode.

14. The non-transitory computer readable medium of claim 13, the circuitry described in the data structure further including a separate memory area configured to be accessible to the first processing unit and the HCE for authenticating at least a portion of the first processing unit's microcode.

15. The non-transitory computer readable medium of claim 14, wherein the separate memory area includes a cache.

16. The non-transitory computer readable medium of claim 14, wherein the first processing unit, the HCE, and the separate memory area are located on the same semiconductor substrate.

17. A method of authenticating a microcode patch comprising the steps of:
copying microcode patch data into a storage area; and
instructing a hardware cryptographic engine (HCE) to perform a cryptographic operation on the microcode patch data.

18. The method of claim 17, further comprising obtaining the results of the cryptographic operation from the HCE.

19. The method of claim 17, further comprising testing for the availability of the HCE before instructing the HCE to perform the cryptographic operation.

20. The method of claim 19, further comprising obtaining an address of the HCE from a software routine.
